(19) United States
(12) Patent Application Publication
(10) Pub. No.: US 2007/0033258 A1
(43) Pub. Date: Feb. 8, 2007

(54) System and method for an email firewall and use thereof

(76) Inventors: Walter Vasilaky, Upper Saddle River, NJ (US); Murali Devi, Great Neck, NY (US)

Correspondence Address: BAY AREA INTELLECTUAL PROPERTY GROUP, LLC, PO BOX 210459, SAN FRANCISCO, CA, 94121-0459, US

(21) Appl. No.: 11/495,476

(22) Filed: Jul. 28, 2006

Related U.S. Application Data
(60) Provisional application No. 60/706,077, filed on Aug. 4, 2005.

(51) Int. Cl. G06F 15/16

(52) U.S. Cl. 709/206

(57) ABSTRACT

One aspect of the present invention provides an Email Firewall system and/or method, which is a system for selective delivery of electronic mail (email), within the framework of conventional email protocols, and authentication of the source of electronic mail, with an objective of blocking unwanted email. In one embodiment of the present invention, the system resembles a firewall in the sense that the Email Firewall checks if the sender has “clearance” before forwarding the email message to the recipient and a means for providing “clearance”.

### CROSS-REFERENCE TO RELATED APPLICATIONS

The present Utility patent application claims priority benefit of the U.S. provisional application for patent Ser. No. 60/706.077 filed on Aug. 4, 2005 under 35 U.S.C. 119(e).

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, hut otherwise reserves all copyright rights whatsoever.

### FIELD OF THE INVENTION

The present invention relates generally to anti-SPAM measures. More particularly, the invention relates to anti-SPAM measures which use email firewalls and private email addresses to block SPAM.

### BACKGROUND OF THE INVENTION

A significant problem with email from the user's prospective is unwanted email. Unwanted email falls under many labels, for example: unsolicited ads (SPAM), forged information requests (pfishing), forges of email headers (spoofing) and the like. In addition, undesirable side effects, which are a result of unwanted email, such as the spread of computer viruses and more recently the probing of a domain names for valid email addresses, known as Directory Harvest Attacks (DHA), Denial-of-Service, further aggravates the problem of unwanted mail. Conventional methods for curtailing SPAM and their shortcomings will next be discussed.

Filtering content methods try to recognize unwanted email by analyzing the content of an email message. An email message that contains certain key word(s), phrases or word patterns may be determined as SPAM. Some notable problems with filtering content are: Filters sometimes incorrectly filter legitimate email messages and thus may block important mail. Filters are not always effective in blocking unwanted SPAM because SPAMmers stay ahead of filters by cleverly adapting to the filters.

Authenticating the source of the email is done by verifying that the domain name of the source and the IP address of the source match as registered. There have been several well publicized proposals (Computerworld May 31, 2004) for authenticating the source, for example: (RMX) Reverse Mail Exchange, (SPF) Sender Permitted From (SPG), (DMP) Designated Mailers Protocol, Sender ID Framework (Microsoft), and “DomainKeys” domain-level authentication framework (Yahoo), to name a few. A significant problem with the “authenticating the source” approach is that the associated protocols and software would have to be widely accepted to be successful. Another problem is that all these approaches are disruptive to the Internet Service Provider (ISP) and sometimes the user or both. Disruptive to ISPs because they have to modify existing software, conform to new protocols or engage third party services. Disruptive to users because some methods require installation of additional software or perform some additional task in order to send or receive email.

Charging the sender per email could curtail unwanted email, SPAM in particular, based on the premise that it would become too expensive to send thousands of email messages on a daily basis. There are several problems with the “charging the sender” approach to curtail SPAM. The idea of paying per message is not appealing to the general public. The exclusion of economically disadvantaged countries, organizations and individuals could be economically and politically undesirable if not unethical. The difficulty and complexity of handling various currencies and payments and the difficulty of agreed standards among ISPs on how to handle payments are problems as well.

Multiple address schemes where a user may have several addresses that map into the same inbox. Current multiple address schemes assign a separate address to either an individual or a group to reach the recipient. Although this idea is not new the novel feature in recent applications is that an address can be created dynamically on the fly, if need be. All known multiple address schemes formulate mail blocking policy as a function of the destination address. This approach relies on the premise that legitimate users will not share an address with spammers; consequently a spammer can not get through since the private address is only known to a legitimate user. There are several major drawbacks with this approach. First, since an assigned address can be shared with anyone it is vulnerable to being discovered by spammers. Second, the technology of creating an address on the fly requires a complex tightly coupled interface with the email provider's software, i.e.. it is difficult to deploy. Third, it uses auxiliary methods. Such as filtering content on messages that do not use pre-assigned private addresses. This not only adds complexity but also opens the possibility of false positives (illegitimate mail that gets through) and false negatives (legitimate mail that doe not get through). Finally it lacks the potential of ultimately achieving complete transparency and security.

In view of the foregoing there is a need for improved techniques that more reliably, transparently, and easily address the problem of unwanted email.

### BRIEF DESCRIPTION OF THE DRAWINGS

The present invention is illustrated by way of example, and not by way of limitation in the figures of the accompanying drawings and in which like reference numerals refer to similar elements and in which:

FIG. 1 illustrates an exemplary partial flow-cart and block diagram of an Email Firewall according to an embodiment of the present invention, wherein an email sender not behind an Email Firewall (non-subscriber) is attempting to contact a recipient behind an Email Firewall, using the recipient's existing email address;

FIG. 2 illustrates an exemplary partial flow-cart and block diagram of an Email Firewall according to an alternate embodiment of the present invention, wherein an email sender (non-subscriber), who is registered and is not behind an Email Firewall, sends an email to a subscriber using the subscriber's private address according to the teachings of the present invention;

FIG. 3 illustrates an exemplary partial flow-cart and block diagram of an Email Firewall according to an alternate embodiment of the present invention wherein an email sender/subscriber behind an Email Firewall sends an email to a recipient/non-subscriber not behind an Email Firewall,

FIG. 4 illustrates an exemplary partial flow-cart and block diagram of an Email Firewall according to an alternate embodiment of the present invention wherein an email sender/subscriber behind Email Firewall initiates a correspondence with another recipient/subscriber behind an Email Firewall.

FIG. 5 illustrates a diagram of an exemplary Unified Modeling Language (UML) system that suitable carry out embodiments of the present invention as illustrated in FIGS. 1 and 2;

FIG. 6 illustrates a diagram of an exemplary Unified Modeling Language (UML) system that suitable carry out embodiments of the present invention as illustrated in FIG. 3. The UML diagram models the interactions the servers: sender's mail server, Firewall Mail Server, Firewall Database, and the recipient's mail server, in accordance with an embodiment of the present invention;

FIG. 7 is an exemplary UMI, diagrams which, in accordance with an embodiment of the present invention illustrates the steps where the sender in FIG. 6 uses the recipients private address.

FIGS. 8 and 9 illustrate a diagram of an exemplary Unified Modeling language (UML) system that suitable carry out embodiments of the present invention as illustrated in FIG. 4. The UML diagrams which, in accordance with an embodiment of the present invention, model the interactions of seven servers: sender's mail server, Firewall Mail Server, Firewall Database and the recipient's mail server, Firewall Mail Server, and Firewall Database;

FIG. 10 is an exemplary UML diagrams which, in accordance with an embodiment of the present illustrates the steps where the email sender behind an Email Firewall is attempting to contact a recipient behind an Email Firewall after the first contact has been established between the correspondents;

FIG. 11 illustrates the various exemplary registration options representing possible levels of registrant's authentication;

FIG. 12 illustrates a progression of optional exemplary security tightening levels;

FIG. 13 illustrates a typical computer system that, when appropriately configured or designed, can serve as a computer system in which the invention may be embodied;

Unless otherwise indicated illustrations in the figures are not necessarily drawn to scale.

### SUMMARY OF THE INVENTION

To achieve the foregoing and other objects and in accordance with the purpose of the invention, a variety of email firewall techniques for blocking unwanted emails are described.

Unwanted contacts can occur in any type of communication or delivery system, especially in modem email systems. An aspect of the present invention is to curtail unwanted contacts or delivery in a communication or delivery system where, by way of example, and not limitation, the addressing scheme is: 1) a hierarchical partitioning of the address space 2) lowest sub-partitions have a sufficiently large pool of admissible addresses to allow each location within a partition to have a possibly different virtual address (private address) for each delivery source, 3) the possibly different virtual addresses (private address) assigned to the same location have identical parts, with the exception of the lowest level, that identify partition levels in the hierarchy 4) there is a feasible means of registering the source address and the corresponding destination private address with the administrator of the destination lowest address partition, 5) and there is a feasible means of notifying, the sender at the source address which private address to use to reach the destination. Thus, the present blocking policy is a function of the source address and is implemented at the lowest sub-partition level of an addressing scheme.

An aspect of the preferred embodiment of the present invention is that when two correspondents are subscribers then not only the system is totally transparent but is totally secure. By totally transparent we mean that email communication is done as before, no one has to register to initiate mail or do anything different than was done before subscribing. By using encryption to detect a message from an Email Firewall by a destination Email Firewall and optionally switching to a secure socket layer communication, the system is completely secure. Furthermore there is no need to have a central repository to keep track of all email providers that offer the proposed Email Firewall service, because a message from an Email Firewall can be detected by an arbitrary destination Email Firewall through encryption of a hidden header field.

The above general description of some embodiments of the present invention clearly distinguishes it from other multiple address approaches. Other multiple address schemes formulate policy for blocking mail based on the destination address whereas our approach formulates policy based on the source address. Consequently with other multiple address schemes multiple addresses can be shared where as with our approach multiple addresses can not be shared. Another consequence of formulating policy based on the source address is that the recipient has greater control as to who may send him/her email.

This invention should not be confused with an auto-white-list since this invention permits messages from correspondents not on the white-list and does not necessarily block email from source addresses that have been compromised. This invention should not be confused with other multiple address schemes since other multiple address schemes formulate email blocking policy based on the destination address and do not use an encrypted hidden header field.

One embodiment of the present invention provides an Email Firewall system and/or method, which is a system for selective delivery of electronic mail (email), and authentication of the source of electronic mail, with an objective of blocking unwanted email. In one embodiment of the present invention, the system resembles a firewall in the sense that the Email Firewall checks if the sent mail has “clearance”, where the clearance policy is a function of the source address.

Yet another aspect of the present invention is that users who corresponded prior to the acquisition of an E-mail Firewall can still use the original address to reach an address behind an Email Firewall

Still another aspect of the present invention is that it curtails unwanted mail such as SPAM, spoofing DHA, viruses, and the like. In addition, a preferred Email Firewall Server embodiment of the present invention can operate with any protocol standard such as SMTP, POP, IMAP, SSL, HTTP (web based email), and the like.

Another aspect of the preferred embodiment of the present invention is that the Email Firewall is virtually transparent to the subscriber in the sense that a subscriber need not be aware of the Email Firewall when sending and receiving mail and is totally transparent when both correspondents are subscribers.

In one embodiment of the present invention, when a subscriber sends an email message to a new contact, the system generates a private return address and if the address is that of an existing contact, the Email Firewall looks up the return private address so that the recipient can always reach the subscriber using the private return address.

One aspect of the present embodiment is that should a private address become publicly known, the private address cannot be used unless the message is sent from the address associated with a private address. Hence a private address can not be shared with anyone.

An aspect of the present invention is that a subscriber's public address is associated with one or more private addresses and a possibly a different private address for each source address.

In one embodiment of the present invention a subscriber may assign a sharable private address to a potential correspondent who is not registered. This is the only exception to the general policy of the invention that private addresses are not sharable. In this case the correspondent can get through only once using the assigned sharable address unless the recipient registers the source address that is using the sharable address. In addition the system limits the number of times the address can be shared. This embodiment accommodates cases where we do not expect that someone will register, for example an automatic replay system as in on-line auctions.

Various method, systems, and means embodiments are described that at least achieve some or all of the foregoing aspects and embodiment.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognized a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternatives embodiments do not necessarily imply that the two are mutually exclusive.

The present invention will now be described in detail with reference to embodiments thereof as illustrated in the accompanying drawings.

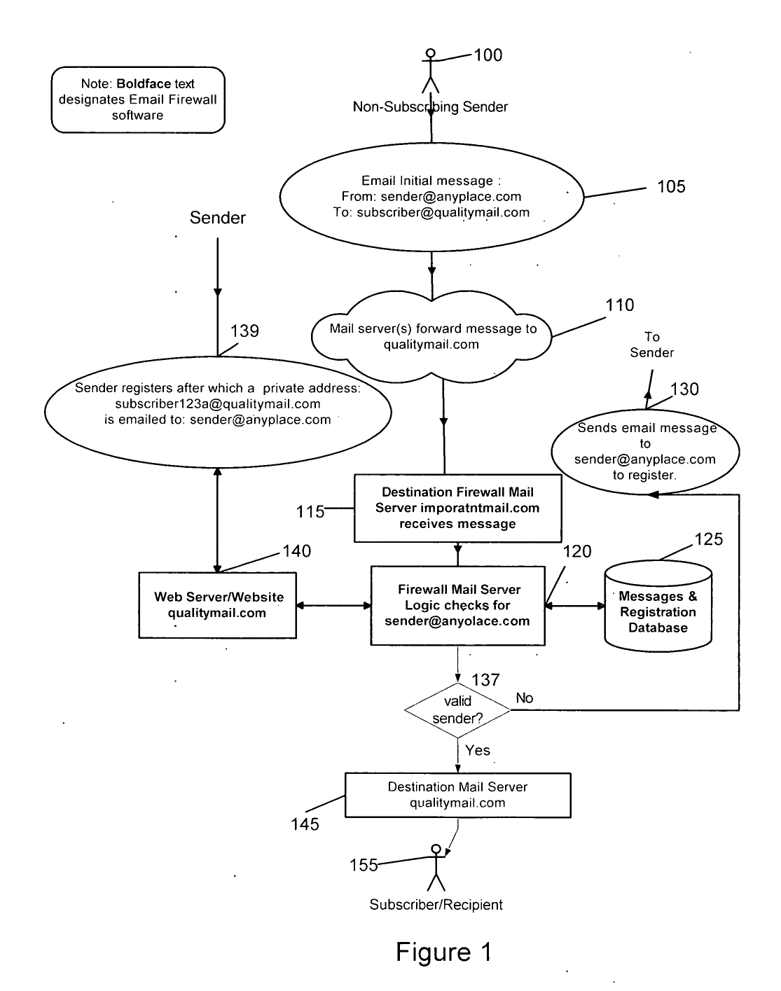

FIG. 1 illustrates an exemplary combined flow-cart and block diagram of an Email Firewall according to an embodiment of the present invention. As shown in the Figure, an email sender not behind an Email Firewall (non-subscriber) is attempting to contact a subscriber/recipient behind an Email Firewall, using an existing email address, (hereinafter “public address”). The process begins at Step 105 where a non-subscribing sender 100 emails an initial message from sender@anyplace.com to a subscriber/recipient's public address at subscriber@qualitymail.com. Non-subscribing sender 100 can be a person using an email system or any system capable of sending an email. In the preferred embodiment, the subscriber is either assigned or can use an existing public address, which the subscriber can use to send email anywhere in the word. However for receiving email, the subscriber will preferably but not necessarily have a unique variant of the public address for each source email address the subscriber corresponds with, hereinafter “private address”. Every private address is preferably assigned to at least one sender's source email address. The system of the present embodiment generates a private address by possibly appending the user name, the part to the left of ‘@’ sign, of the subscriber's public address with an extension string of one or more alphanumeric characters. For example, if the sender's address is sender@anyplace.com and the subscriber's public address is subscriber@qualitymail.com then a private address corresponding to sender@anyplace.com can be subscriber123a@qualitymail.com. The exemplary implementation shown uses 4 characters for the extension string which will allow up to 1,679,616 private addresses for each subscriber. In other words, the subscriber can communicate with up to 1.6 million e-mail addresses. However, the Email Firewall of the present invention is only limited by the number of characters allowed in a user name, which currently is 64 characters, the position of the extension string in the local part of the address, the type of characters in the extension string within the allowable set of characters, and the like. A private address is a valid email address and has the same domain name as the subscriber's public address. Given that a private address is valid, the private address will be forwarded across any number of intermediate email transfer agents to the designated server on which the e-mail firewall is installed. Note that a private address is a virtual address that is managed by the destination Email Firewall server and logic and not by the final destination email server. It should be noted that in order to implement an Email Firewall it is preferable to reserve in advance a block of addresses that can be used as private addresses. But this is not a problematic constraint since 64 characters are allowed in the local-part (user name) of the e-mail address and each character can be any of these ASCII characters: uppercase and lowercase letters, the digits 0 through 9, the characters ! # $ % & + − / = ? ˆ _ '{ | } , and the character “.” provided that it is not the first or last character in the local-part, permits the total number of user names possible for each domain to be virtually infinite, i.e., 64 to the power 50. Reserving a block of addresses in advance avoids the necessity of interfacing an Email Firewall with the email provider's subscriber database.

In a practical implementation it would be convenient to make the private address the same as the public address, for example, both would be subscriber@qualitymail.com and hence the private address category and the pubic address category would hold the same value, subscriber@qualitymail.com, in the validation database. This is possible because while the addresses are the same they are stored under different categories in the database. In this case the system would only change this private address, for example, to another private address Such as subscriber123a@qualitymail.com only if private/public address subscriber@qualitymail.com address were compromised. However, should a registered sender forget a private address it will be possible to look it tip by logging in at a designated website. Note that the case where the private address is the same as the public address is not equivalent to a, so called. “White List” because mail from addresses not on the white list can still reach an address behind an Email Firewall provided the sender registers. In a “White List” if an address is compromised, for example spoofed, then the available options are either blocking that spoofed address or asking the individual to get a new email address. However in this invention no Such drastic measures are necessary because all that is necessary is to change the private address. Yet another aspect is that users who corresponded prior to the acquisition of an Email Firewall can still use the original address to reach an address behind an Email Firewall. The recipient behind the newly acquired Email Firewall would register all prior source addresses making the private address optionally the same as the public address.

Continuing with the Figure, the email is optionally forwarded at Step 110 by one or more anonymous email transfer agents to the destination Firewall Mail Server 115. It should be appreciated that the sent email is not required to be forwarded by an anonymous mail server at Step 110, and could, instead, go directly to the Firewall Mail server 115.

After arrival at Step 120, the Firewall Mail Server's logic checks the message and a registration database 125 to verify that the recipient's address (subscriber@qualitymail.com) is a public address and that the source address is not in the message and registration database 125. The email message is marked, for example, with “Message from unrecognized address” and is preferably, but optionally placed into a designated folder. The type of message and registration database 125 used can be implemented using a variety of schemes such as, but not limited to relational database, directory services, flat files, and the like. If at Step 137 the sender is determined to be from an unknown source address, an automatic email message is preferably, but optionally, sent at Step 130 back to non-subscribing sender 100 at sender@anyplace.com requesting that the non-subscribing sender 100 obtain a private address by registering Step 139, at a specified website at Step 140. An example of a message could be: “The e-mail message you have sent to subscriber qualitymail.com was marked Message From Unrecognized Address and was not placed into the usual subscriber's Inbox folder. In order for us to forward the message to its final destination and have future messages placed in the Inbox folder please register at, for example: www.qualitymail.com/register and a subscriber's Private Address, for example: subscriber123a@qualitymail.com, will be automatically emailed to you. Moreover, the registration process may be as simple as typing an alphanumeric string displayed as a graphic (captcha) to insure that a person and not a program is registering or requiring that the registrant input an identifier mailed in the registration email message or something more complex such a credit card registration. The sender may use this private address to mail messages from sender@anyplace.com to this subscriber.” In the present example, because the recipient's address is public and the source address is not registered, the email does not reach a destination mail server 145, which derivers email to subsciber/recipient 155. When initiating a new contact, the sender 100 may need to resend the email message using the subscriber/recipient 155 private address subscriber123a@qualitymail.com or if the registration is more rigorous then the registrant is notified at the registration web site that the stored message will be forwarded to the recipient 155 and that there is no need to resend the message. It should be appreciated that the registration is preferably done once for each source address. Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the Email Firewall system of the present embodiment may be implemented using any of a wide variety of suitable processes and system modules, and is not limited to any particular computer hardware, software, firmware, microcode and the like.

The preferred embodiment of the present invention is intended as an add-on stand alone executable for email service providers or Internet Service Providers (ISP); The stand alone application is made up of Email Firewall software which communicates with one or more designated email server(s) (hereinafter “Firewall Mail Server”), a web server, and a message and registration database. Mail that is “cleared” by the Email Firewall is forwarded to the ISP's existing mail server. An aspect of the present invention is that it curtails unwanted mail Such as SPAM, spoofing DHA, viruses, and the like by blocking mail that is not “cleared.” In addition, the preferred Email Firewall Server embodiment of the present invention can operate with any protocol standard such as SMTP, POP, IMAP, SSL, HTTP (web based email), and the like. In particular, the preferred Email Firewall Server embodiment of the present invention preferably does not rely on the SMTP protocol to block unwanted mail. Another aspect of the present embodiment is that the Email Firewall is transparent to the subscriber in the sense that a subscriber need not be aware of the Email Firewall when sending and receiving mall. For example, the subscriber is preferably not required to install software, e-mail administration, and the like. Furthermore when sending and receiving email the subscriber does not see or use private addresses. Only a non-subscriber may have to use a private address, in the To: header field to reach a subscriber, but even then the private address may be the same as the public address. Even though the private and the public address may be the same they are. However, both stored indifferent places and associated with a source address. Given that the preferred Email Firewall embodiment is preferably implemented as an add-on executable module, the Email Firewall does not require the ISP to modify and/or change any existing software or services. Furthermore, the present Email Firewall embodiment identifies the source of the email without a third party registry. Moreover, the preferred Email Firewall embodiment is relatively simple to install in a typical deployment all that is necessary is one or mole designated email server(s) which receives all incoming mail, Email Firewall software, which forwards selected mail to an e-mail provider's existing mail server(s), a web server and a database to keep track of private addresses and a set of reserved addresses. Since the Email Firewall does not filter mail based on content the Email Firewall will not reject legitimate mail (false positive) nor pass through SPAM based on content (false negative). The Email Firewall does not require charging the sender to send email to a subscriber.

In the preferred embodiment, a Firewall Mail Server designated to initially receive mail, sharply forwards “cleared” email to the ISP's existing mail server. As a result, an existing ISP's original mail server and software will stay intact. By implication any existing method to curtail unwanted mail Such as Microsoft's s Sender ID, Yahoo's DomainKeys or pay per mail, as described in U.S. Patent 20040181571, U.S. patent application Ser. No. 10/805,81 and U.S. Pat. No. 6,587,550 respectively, need not be eliminated or altered.

One aspect of the present embodiment is that should a private address become publicly known, the private address cannot be used unless the message is sent from the address associated with a private address. A SPAMmer will not be able to send SPAM to a subscriber unless she/he registers for each recipient and is assigned a Subscriber's private address associated with the SPAMmer's address. Spoofing a sender's email address to send a message to a subscriber is no longer possible unless the correct corresponding private address is used. If a SPAMmer sends a message from spammer@spamserver.com to subscriber123ab@qualitymail.com the message will not get through because mail to subscriber123ab@qualitymail.com can only be sent from sender@anyplace.com.

If a SPAMmer or any mail sender discovers both the private address subscriber 123ab@qualitymail.com as well as the corresponding sender's address sender@anyplace.com, and spools the assigned address sender@anyplace.com then the subscriber can change the private address at the ISP's web site and the sender is automatically notified of the change. In this way, a SPAMmer can no longer carry out a mass mailing campaign from one location since every private address requires a matching source address. Moreover, what is known as Directory Harvest Attacks (DHA) will only be able to discover public addresses since all other tried addresses will be rejected because the source address will not match.

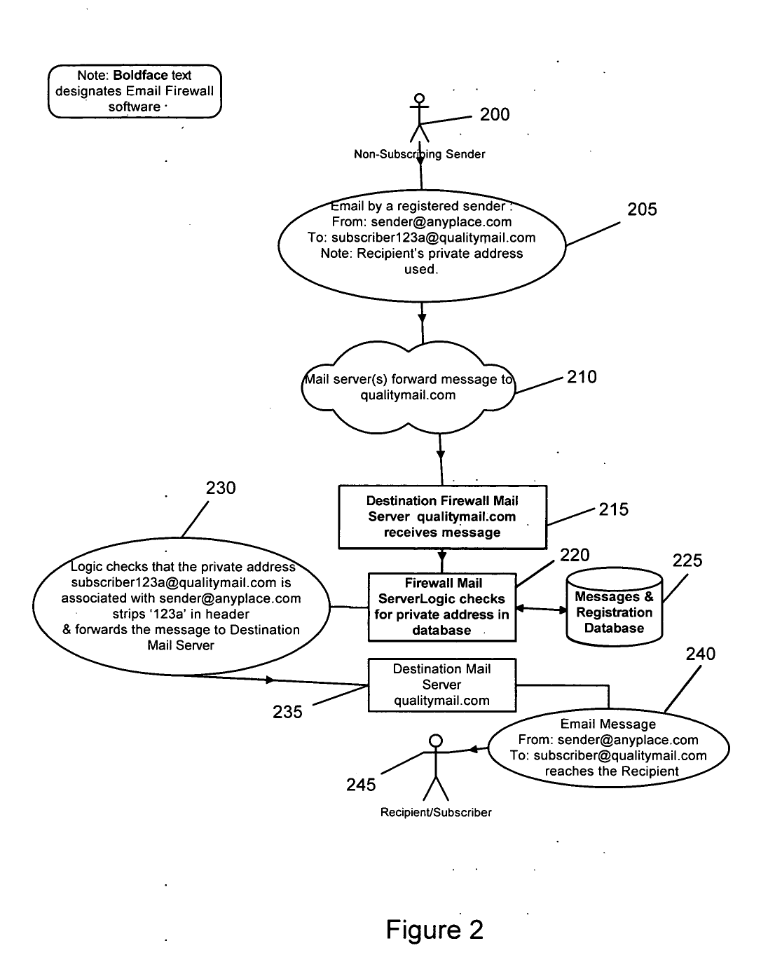

FIG. 2 illustrates an exemplary combined flow-cart and block diagram of an Email Firewall according to an alternate embodiment of the present invention. The present embodiment exemplifies the situation where an email sender (non-subscriber), who has registered and is not behind an Email Firewall, sends an email to a subscriber using the subscriber's private address according to the teachings of the present invention. In the Figure, a non-subscribing sender 200 emails an email message at Step 205 from sender@anyplace.com to a subscriber/recipient's private address at subscriber123a@qualitymail.com. Non-subscribing sender 200 can be a person using an email system or any system capable of sending an email. The email is optionally forwarded at Step 210 by one or more anonymous email transfer agents to a destination Firewall Mail Server 215; however, the email is not required to be forwarded by an anonymous mail server and could go directly to Firewall Mail Server 215. After arrival at Step 220, the Firewall Mail Server's logic checks the message and registration database 225 to verify that the recipient's address (subscriber123a@qualitymail.com) is a private address stored in the message and registration database 225. At Step 230, the Firewall Mail Server's logic checks that the private address subsciber123a@qualitymail.com is associated with sender@anyplace.com. The Email Firewall strips the “123a” extension String out of the destination email address and forwards the message to a destination mail server with the email address subscriber@qualitymail.com. Note that since the database contains all three associated addresses subsciber123a@qualitymail.com, subscriber@qualitymail.com, and sender@anyplace.com there is no difficulty in identifying the extension string in the private address. At Step 235, the destination mail server receives the email message from sender@anyplace.com and addressed to subscriber@qualitymail.com, and at Step 240 sends the email so that a subscriber/recipient 245 can property receive the email message.

Another aspect of tie present embodiment is that viruses are curtailed and win not propagate to other subscribers because the present Email Firewall strips the extension string appended to the sender's private return address in Step 230 before the “cleared” email reaches Steps 240 and 245. Accordingly, a computer virus (worm) will be able to not copy return private addresses of other subscribers; a message sent by a virus to another subscriber's public address will be intercepted as if it were initial mail from a non-registered sender. However non-subscribers are still vulnerable to the propagation of viruses.

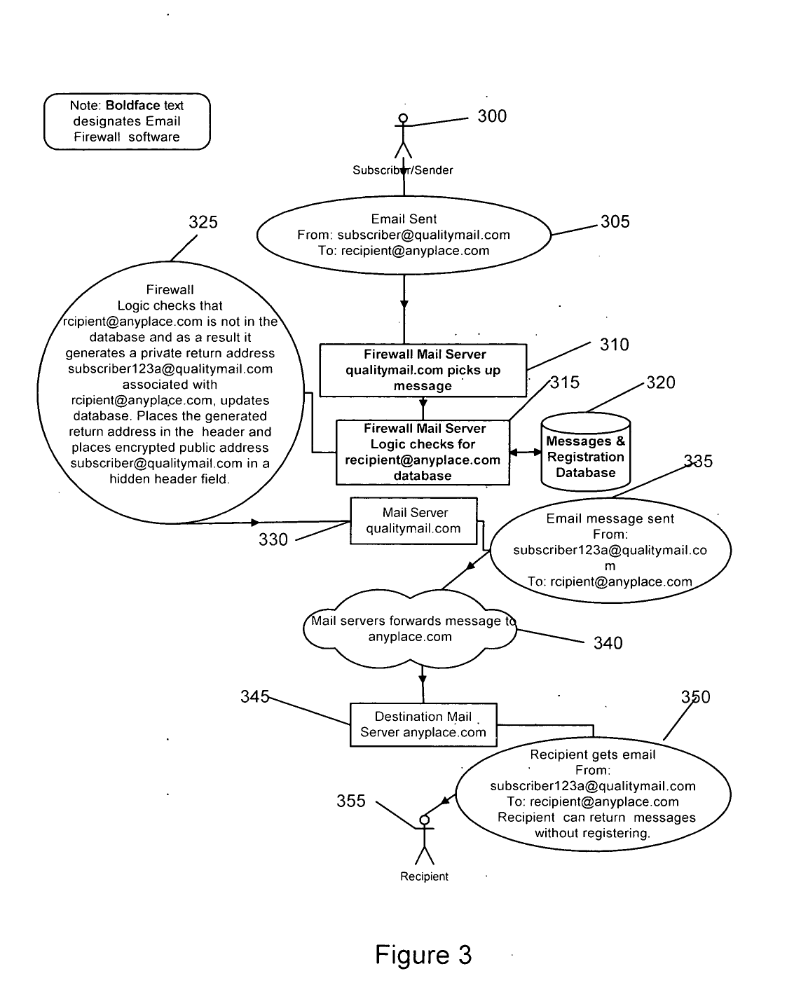

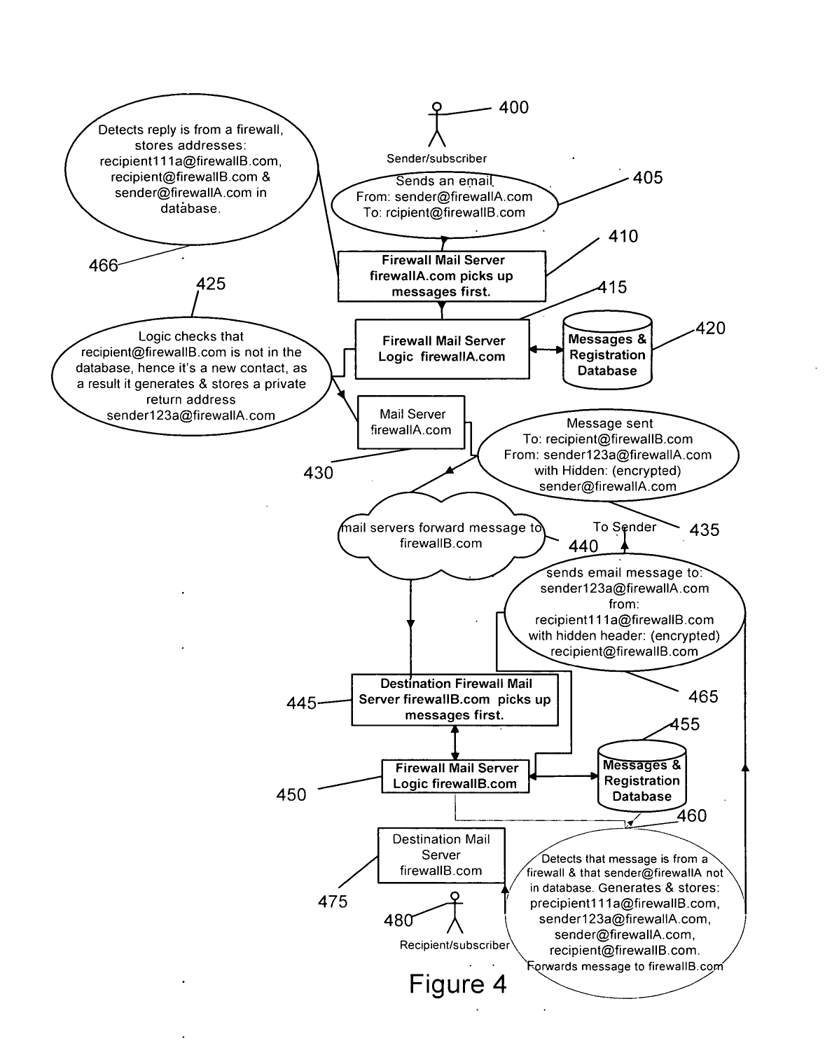

FIG. 3 illustrates an exemplary combined flow-cart and block diagram of an Email Firewall according to an alternate embodiment of the present invention. The present embodiment exemplifies the situation where an email sender/subscriber behind an Email Firewall sends an email to a recipient/non-subscriber not behind an Email Firewall. The process begins at Step 300, where a sender/subscriber sends an email message (shown without limitation as 305 by way of example) from subscriber@qualitymail.com addressed to recipient@anyplace.com. At Step 310, the email message arrives at the subscriber's Firewall Mail Server. At Step 315, the Firewall Mail Server's logic checks the message against a registration database 320 to determine if the recipient's address is not in the message and registration database 320, in which case implies the email message is a new correspondence. At step 325, the Firewall Mail Server 310 generates a private extension string (by way of example, and not limitation, “123a”) and inserts it into the email address to create the private return address subscriber123a@qualitymail.com. The private address subscriber123a@qualitymail.com is associated with recipient@anyplace.com and, public-address subscriber@qualitymail.com in the message and registration database 320. If the email is not a new correspondence a corresponding extension string is retrieved from registration database 320 and inserted in the header the return address to create the appropriate private return address. Furthermore an encrypted public address subscriber@qualitymail.com is inserted into a hidden header field. The hidden header field will be ignored by email transfer agents including intermediate Email Firewall transfer agents but will be detected by recipient Email-Firewall software. We insert the encrypted private address so that in case the destination is also an Email Firewall then the email firewall server logic would be able to authenticate the public source address and that the message is from another firewall. The encryption of the public address, discussed in more detail in FIG. 4. At Step 330, the email is sent from subscriber123a@importantmail.com and addressed to recipient@anyplace.com by a subscriber/sender's mail server. The email is optionally forwarded at Step 340 by one or more intervening anonymous email servers to the destination mail server for anyplace.com; however, the email is not required to be forwarded by an anonymous mail server and could, instead, go directly to the destination mail server for anyplace.com. At Step 345, the destination mail server for anyplace.com receives the message from subscriber123a@qualitymail.com addressed to the recipient at the mail address recipient@anyplace.com. At Step 350, the email is sent to recipient 355, who can return messages to sender/subscriber 300 without registering because recipient 355 has the sender/subscriber's private return address. It should be understood that, in the present example, if a subscriber initiates a correspondence with a non-subscriber then the non-subscriber does not have to register to communicate with the subscriber. It should be understood that this procedure would not change if the generated return address were the same as the source address. The validation database would simply contain the same value, subscriber@qualitymail.com, in the private address and public address categories where both would be associated with the destination address, recipient@anyplace.com.

FIG. 4 illustrates an exemplary combined flow-cart and block diagram of an Email Firewall according to an alternate embodiment of the present invention. The present embodiment exemplifies the situation where an email sender/subscriber behind an Email Firewall initiates a correspondence with another recipient/subscriber behind an Email Firewall. The process begins at Step 405 with a sender/subscriber 400 sending an email message from sender@firewallA.com addressed to recipient@firewallB.com. The email message arrives at the sender/subscriber's Firewall Mail Server at Step 410. At Step 415 the Firewall Mail Server's logic checks the message and registration database 420 to determine if the recipient's public address in the message header is not in the registration database 420, which implies the email message is a new correspondence. At Step 425, the Firewall Mail Server generates a private address extension string (by way of example, and not limitation, “123a”) and inserts it into the return email address to create a private return address (sender123a@firewallA.com). The private address sender 123a@firewallA.com is associated with its public address sender@firewallA.com and, and destination address recipient@firewallB.com in the message and registration database 420. In addition the Firewall Mail Server logic inserts the encrypted public address sender@firewallA.com, into an appropriately labeled hidden header field. These hidden header fields would be ignored by email transfer agents but would be parsed by the destination Email Firewall software. The encryption insures that spammers do not spoof the sender's address or masquerade as an email-firewall. If the email is not a new correspondence, then a corresponding extension string is retrieved from the registration database 420 and inserted in the email address to create the appropriate private return address sender123a@firewallA.com, which is inserted in the From: header field. The public address, sender@firewallA.com, is encrypted and is inserted into an appropriately labeled hidden header field. At Step 435, the email is sent by the subscriber/sender's mail serve from sender123a@firewallA.com to recipient@firewallB.com with the encrypted return address sender@firewallA.com placed in a hidden header field. The email is then optionally forwarded, at Step 440, by one or more anonymous email transfer agents to the destination Email Firewall mail server for firewallB.com. However, the email is, again, not required to be forwarded by an anonymous mail server(s) and could, instead, go directly to the destination mail server for firewallB.com. The destination Firewall Mail Server for firewallB.com receives the message at Step 445. At step 460, the destination Firewall Mail Server logic 450 checks the message and registration database 455 to determine whether or not the recipient's address is a valid private address. If the recipient's address is not a valid private address, the logic checks for an appropriately labeled hidden encrypted header field. If it finds this encrypted hidden header field then it assumes that someone behind an E-mail Firewall is trying to reach the Recipient for the first time and thus proceeds to store the sender's private address: sender123a@firewallA.com, public address: sender@firewallA.com and recipient's public address: recipient@firewallB.com in the database 455. In addition the logic generates a private return address, by way of example, and not by way of limitation: recipient111a@firewallB.com. The logic stores the generated private return address, the corresponding public addresses sender@firewallA.com and recipient@firewallB.com. At Step 465 an automatic email message is sent back to the Firewall Mail Server 410 using private addresses To: sender123a@firewallA.com and private return address From: recipient111a@firewallB.com. As always the email-firewall logic inserts the encrypted public return address, in this case recipient@firewallB.com, in a hidden header field. It should be noted that the sender need not be aware that the destination address is behind an Email Firewall. An Email Firewall when sending a message will always store an encrypted return public address in a hidden header field, regardless of the destination, which will be ignored by all transfer agents with the exception of a destination Email Firewall. The encryption guarantees the authenticity of the source address for the destination Email Firewall server.

At Step 466, Firewall Mail Server 410 stores addresses recipient111a@firewallB.com, recipient@firewallB.com, and sender@firewallA.com in database 420. Note that now databases 420 and 455 have the public addresses as well as the corresponding private addresses of both the Sender and the Recipient. It should be understood that, in the present embodiment, both the Sender and the Recipient use public addresses in the email headers helice if both the sender and the recipient are behind an Email Firewall their communication is completely transparent. This is possible because the Sender's database 420 and the Recipient's database 455 have each others public and the corresponding private address so that logic 415 or logic 450 can retrieve and replace the public addresses with private addresses when email goes out and replace the private addresses with public addresses when email comes in. Furthermore it is now optionally possible for the two correspondents to switch to a secure socket layer communication. Hence, when both the sender and the recipient are under the protection of an Email Firewall then the two firewalls “recognize” each other through hidden encrypted header fields and automatically proceed to store each others private and public address, a so called “hand shaking” process. Once the “hand shaking” is complete the two correspondents then communicate by using public addresses and yet are still protected by their respective private addresses. Because the private addresses can be changed programmatically at any time, a spammer who spoofs the source address and gets a hold of the private return address as well as the encrypted hidden field would still not be able to get though. Furthermore after the “hand shaking” is complete it is optionally possible to switch to a secure socket layer communication in cases where security is critical. It should be noted that there is no need for a central database that keeps track of all the Email Firewall because an Email Firewall can detect an email from another Email Firewall through the encrypted hidden header. As a consequence as more and more addresses are protected by Email Firewall the necessity to register to reach someone behind an Email Firewall becomes unnecessary.

The above mentioned systems and process allow rejection of unwanted email in a variety of applications. The following examples are illustrative, but not limited to, the above mentioned systems and process for filtering unwanted email. The first example is where a SPAMmer who has learned the private address: subscriber123ab@qualitymail.com associated with an unprotected by a firewall address sender@anyplace.com and tries to send a message using the private address subscriber123ab@qualitymail.com from spammer@spamserver.com address. The SPAMmer will not get through to subscriber123ab@qualitymail.com because the address subscriber123ab@qualitymail.com can only be used to send e-mail from sender@anyplace.com. A second example is where a SPAMmer tries to spoof a registered sender. A SPAMmer has discovered that an email message can be sent from sender@anyplace.com to a subscriber using the subscriber123ab@qualitymail.com address. The SPAMmer spoofs sender@anyplace.com and sends a message to subscriber123ab@qualitymail.com The Subscriber realizes that this private address has been compromised and generates a new private address for sender@anyplace.com. An automatic notification is sent to sender@anyplace.com stating that the new private address is., for example, without limitation, subscriber73222@qualitymail.com. Then when the SPAMmer sends a message to subscriber123ab@qualitymail.com (original private address and spoofs sender@anyplace.com it would get an error message since subscriber123ab@qualitymail.com is no longer valid for sender@anyplace.com. A third example is where a SPAMmer launches directory harvest attack (DHA). The SPAMmer launches a directory harvest attack on the domain qualitymail.com. For each attacking message sent, the SPAMmer is blocked except for public addresses, which are useless to the SPAMmer, no other address will come back as valid because the source address will not be associated with any attempted destination address in the database. Note that in the above examples we could have set the private address to be the same as the public address, namely subscriber@qualitymail.com and still get the same results because mail would not be accepted from all unregistered address. Naturally DHA attacks would be optionally detected by the Firewall Email Server hence shielding the recipient's email server from denial of service attacks as well. A fourth example is when a SPAMmer tries to pose as a Firewall Server in order to establish communication with someone behind an Email Firewall. Such a forgery would be detected by a legitimate firewall server since the hidden header field is encrypted.

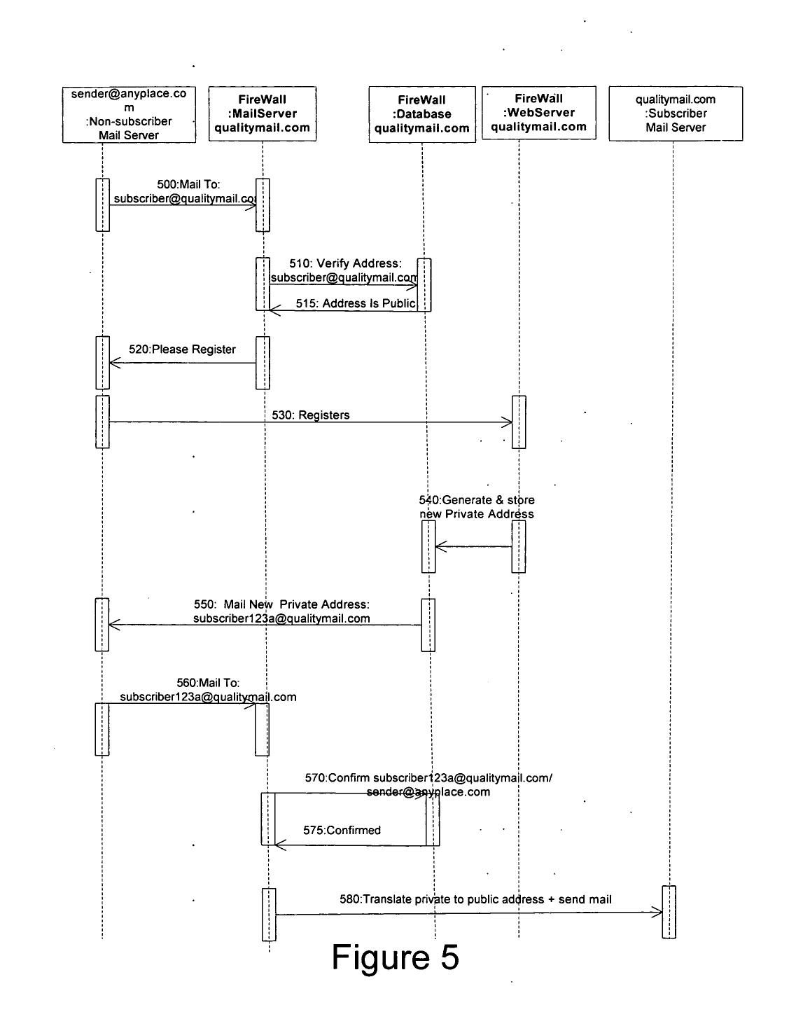

FIG. 5 illustrates a diagram of an exemplary Unified Modeling Language (UML) system that suitable carry out embodiments of the present invention. The Figure models the interactions among the five servers: sender's mail server, destination Firewall Mail Server, destination Firewall Database, destination Firewall Web server, and the recipient's mail server. This illustration is according to an embodiments, discussed in FIGS. 1 and 2 of the present invention, wherein an email sender not behind an Email Firewall is attempting to contact a recipient behind an Email Firewall, using the recipient's existing email address, then acquires a private address and resends the email to the recipient or the mail forwarded to the recipient after the sender registers. It should be noted that it is possible to simply forward the stored blocked message instead having it resent as is done in FIG. 4, but that may depend on the rigor of the registration procedure. The process begins at Step 500 where a non-subscriber's emails an initial message from sender@anyplace.com to a subscriber/recipient's public address at subscriber@qualitymail.com. In step 510 the Firewall logic checks the Firewall Database if sender@anyplace.com is in the database and in Step 515 the logic notifies the Firewall Mail server that subscriber@qualitymail.com is a public address and sender@anyplace.com is not registered. In Step 520 the logic requests the Firewall Mail Server to send an email to sender@anyplace.com to register. In Step 530 the sender is directed to the-Firewall Web Server which generates a registration web page. In Step 540 the logic gets the registration data from the webpage, generates a private address, for example, subscriber123a@qualitymail.com and stores it in the Firewall Database together with sender@anyplace.com and subscriber@qualitymail.com In Step 550 the generated private address is emailed to the sender. In Step 560 the sender emails the message using the generated private address and in Step 570 the logic checks the Email Firewall Database if the private address subscriber123a@qualitymail.com corresponds to sender@anyplace.com. In Step 575 the logic notifies the Email Firewall server that the private address has been verified so that in Step 580 after the logic changes the private address to its corresponding public address forwards the message to the recipients Mail Server which in turn forwards it to the recipient's inbox. This UML diagram is by way of example, and not by way of limitation. As stated above, instead of having to resend the message it is possible to simply forward the message after the sender registers.

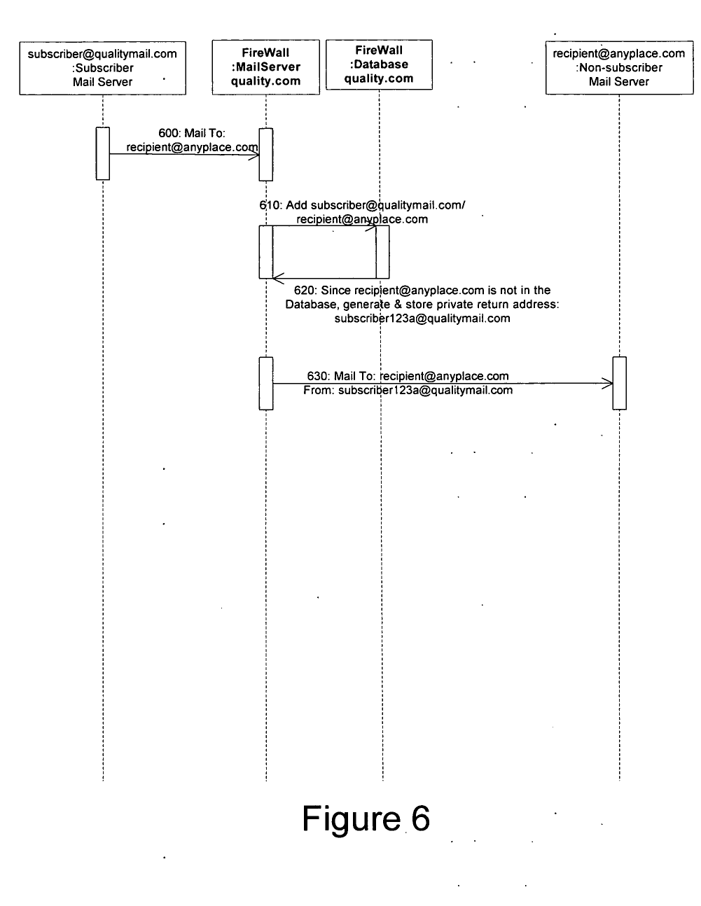

FIG. 6 illustrates an exemplary UML diagram which models the interactions the four servers: sender's mail server, sender Firewall Mail Server, sender Firewall Database, and the recipient's mail server, in accordance with an embodiment of the present invention. The UML model shown specifies, and visualizes, the software logic for the system of the embodiment described for FIG. 3 wherein an email sender/subscriber behind an Email Firewall for the first time sends an email to a recipient/non-subscriber (using the recipient's existing email address). The process begins at Step 600 where a subscriber's email server sends an initial message from subscriber@qualitymail.com to a non-subscriber at recipient@anyplace.com. In step 610 the logic checks if recipient@anyplace.com is in the database and if not then in step 620 the logic generates a private return address, for example, and without limitation subscriber123a@qualitymail.com and stores this address along with its associated addresses recipient@anyplace.com and subscriber@qualitymail.com. In step 630 the Firewall Mail Server mails the message to recipient@anyplace.com with return address subscriber123a@qualitymail.com.

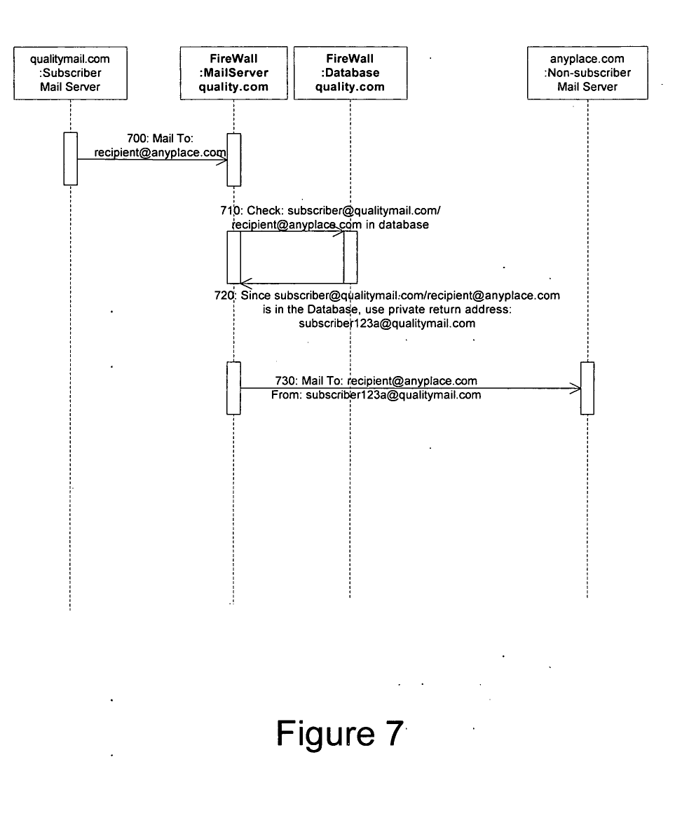

FIG. 7 is identical to FIG. 6 with the exception that an email is sent on a subsequent time by a sender/subscriber behind an Email Firewall to a recipient/non-subscriber not behind an Email Firewall. The steps are the same as in FIG. 6 with the exception of Step 720 where the return address is retrieved from the database instead of being generated as in FIG. 6 Step 620.

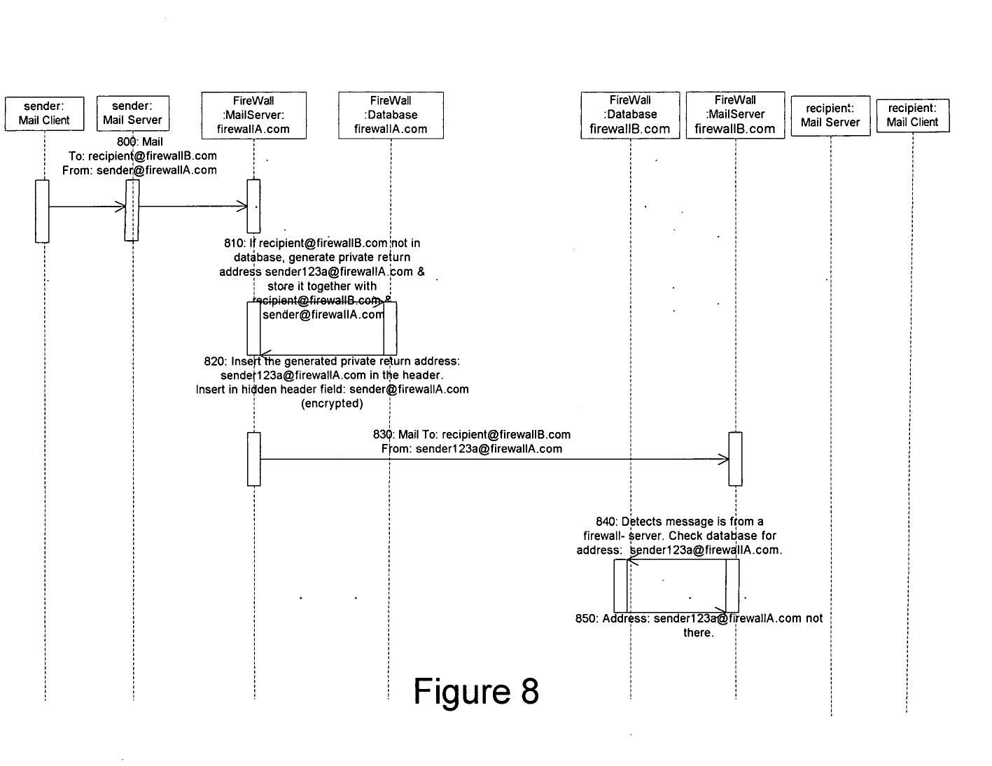

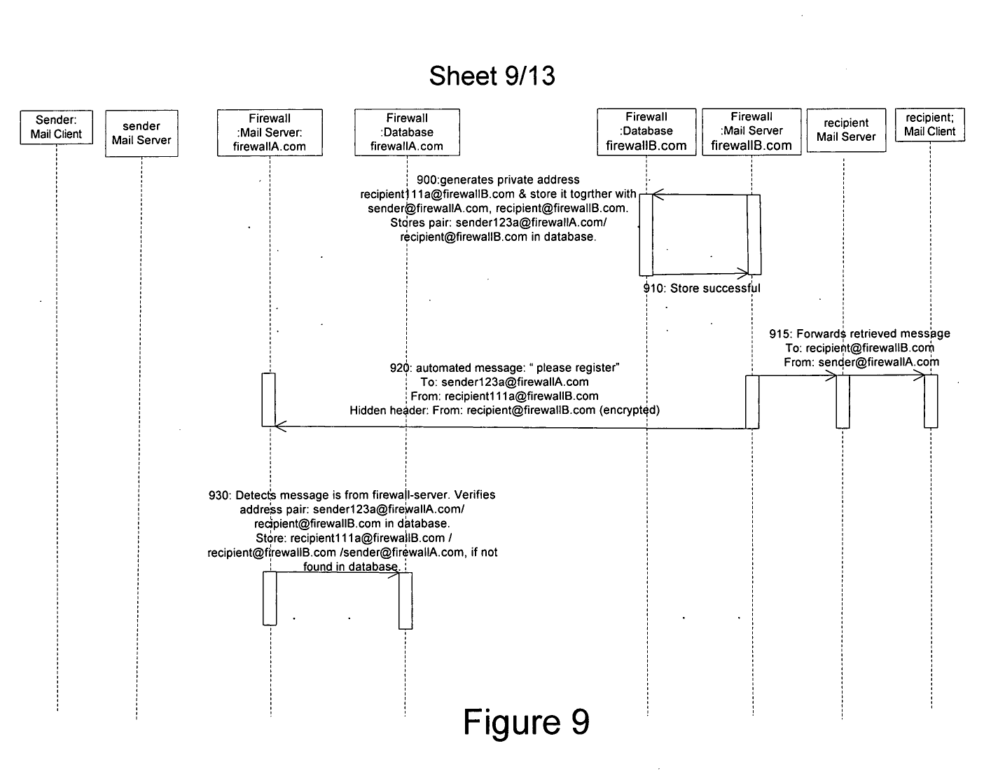

FIGS. 8 and 9 are exemplary UML diagrams which, in accordance with an embodiment of the present invention, model the interactions of six servers: sender's mail server, sender Firewall Mail Server, sender Firewall Database and the recipient's mail server, recipient Firewall Mail Server and recipient Firewall Database. The Figures specify, and visualize, a UML model of the software logic for the system described in the discussions of FIG. 4 wherein an email sender/subscriber behind an Email Firewall for the first time sends an email to a recipient subscriber behind an Email Firewall; The process begins at Step 800 where subscriber sends a message from sender@firewallA.com to recipient@firewallB.com. In Step 810 the Firewall Mail Server's logic checks the database to determine if the recipient's public address is not in the database, which implies the email message is a new correspondence. Then in Step 810 Firewall Mail Server generates a private address sender123a@firewallA.com by possibly appending an extension string (by way of example, and not limitation, “123a”) stores the private address together with its public address, sender@firewallA.com and destination address, recipient@firewallB.com in the database. In Step 820 Firewall Mail Server's logic inserts the generated private return address in the header field From: and places the public address, sender@firewallA.com, in a hidden encrypted header field. In Step 830 the fiewallA.com Firewall Server mails the message with header field values From: sender123a@firewallA.com , To: recipient@firewallB.com, and sender@firewallA.com, in a hidden encrypted header field. In Step 840 the Firewall mail Server firewallB.com determines from the hidden encrypted header that the massage came from an Email Firewall and in Step 850 checks that sender123a@firewallA.com is not in the database which implies that the message is from an unregistered sender. The process continues in FIG. 9. In Step 900 the Firewall Mail Server logic of firewallB.com generates a private return address, by way of example, recipient111a@firewallB.com; stores the sender's private and public address in the database. In Step 910 the Email Firewall is signaled to forward the initial email from sender@firewallA.com to recipient@firewallB.com and In Step 915 Firewall Mail Server: firewallB.com forwards the stored email to the recipient's Mail Client. In Step 920 Firewall Mail Server: firewallB.com sends a generated message to the sender Email Firewall with header fields To: sender123a@firewallA.com, From: recipient111a@firewallB.com and encrypted sender@firewallA.com in the hidden header field. In Step 930 Firewall Mail Server: firewallA.com detects from the hidden header field that the registration message is from a firewall mail server, checks the database that the message is from a registered address recipient@firewallB.com and stores the private address recipient111a@firewallB.com if it is not in the database, together with sender@firewallA.com, recipient@firewallB.com. Note that at this point the firewallA.com and firewallB.com have each others public as well as the corresponding private addresses stored in their respective databases and helice the “hand shake” is complete. As a consequence correspondence between addresses protected an Email Firewall(s) is transparent and there is no need for either correspondent to register.

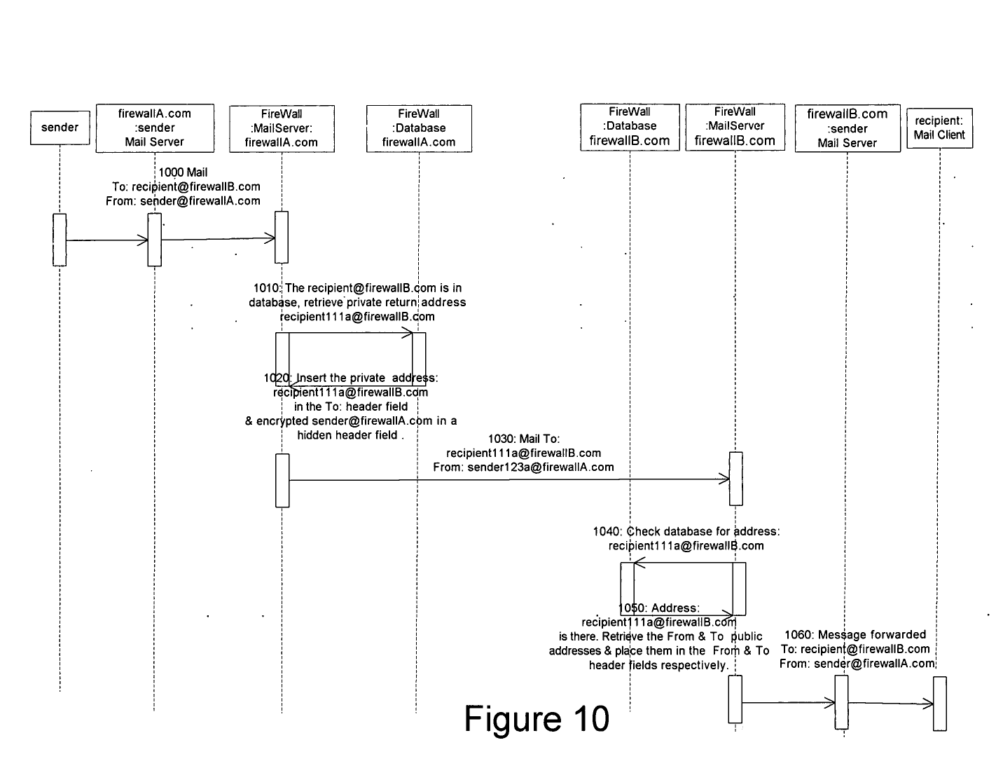

FIG. 10 is an exemplary UML diagrams which, in accordance with an embodiment of the present invention, models the interactions of six servers: sender's mail server sender Firewall Mail Server, sender Firewall Database and the recipient's mail server, recipient Firewall Mail Server, and recipient Firewall Database. The Figures specify, and visualize, a UML, model of the software logic for the system described in the discussions of FIG. 4 wherein an email sender/subscriber behind an Email Firewall sends an email but not for the first time to a recipient subscriber behind an Email Firewall. This is a depiction of an embodiment of Email Firewall to Email Firewall communication after the initial mailing was already done, i.e., the initial “hand shaking” of the two Email Firewalls was successfully completed. The process begins in Step 1000 where subscriber sends a message from sender@firewallA.com to recipient@firewallB.com In Step 1010 the Firewall Mail Server's logic checks the database to determine if the recipient's public addresses is in the database, which implies the email message is not a new correspondence and retrieves the private address sender123a@firewallA.com. In Step 1020 Firewall Mail logic inserts the retrieved private address into the From: header field. In Step 1030 the Firewall Mail Server forwards the email To: recipient@firewallB.com and From: sender123a@firewallA.com. In Step 1040 the recipient's Firewall Mail Server logic checks the firewallB.com database for sender123a@firewallA.com and retrieves the corresponding public address sender@firewallA.com and in Step 1050 places it in the From: address field. In Step 1060 the email is forwarded To: recpient@firewallB.com, From: sender@firewallA.com which is in turn forwarded to the recipient's Mail Client. It should be pointed out that for additional security it is possible to configure the Email Firewall to programmatically and transparently change the private addresses between two established correspondents.

Those skilled in the art can implement the embodiments of the present invention based on the figures, their descriptions, and UML diagrams. A typical computer system in which the invention may be embodied is one that, when appropriately configured or designed, can execute instructions written preferably in a procedural language such as C and/or Object Oriented languages such as C++, C# or Java. However the implementation is not dependent on any particular computer language, web server, database management system, or computer hardware architecture.

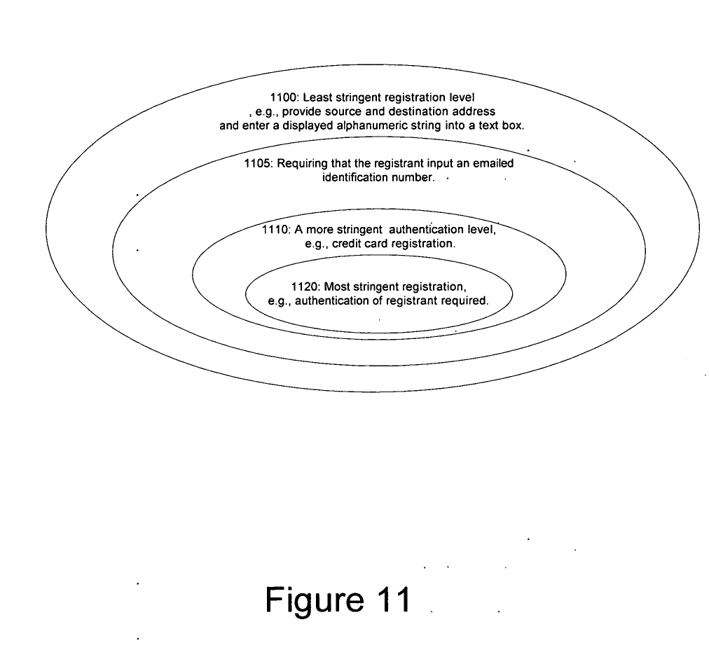

FIG. 11 illustrates the various exemplary registration requirements representing possible levels of registrant's authenticity. In the Figure is shown various exemplary authentication levels indicating selectability and scalability regarding the level of complexity of registration. The levels are depicted as concentric rings where each inner ring represents a more stringent authentication criterion than its immediate outer ring. By way of example, and not limitations a digital signature registration depicted by the most inner ring 1120 may be more secure than a credit card registration depicted in 1110 which in turn may be more secure than a requirement that the registrant enters an identification number sent to the registrant by the destination Email Firewall logic depicted in 1105. Finally the least stringent requirement is depicted in 100, the so called captcha registration which requires just typing an alphanumeric string embedded in a graphic. Captcha was designed to prevent automated registration. The ISP and/or subscriber are provided a set of options to decide on the complexity of the registration process. It is well known that in any practical security system there is generally a trade off between convenience and security. The Email Firewall of the present embodiment allows the subscriber, administrator and the like to appropriately select the level rigor in the registration. The foregoing Email Firewall embodiment is understood not be limited to the above mentioned methods or system implementations and can be administered using other like methods for security.

Authorized bulk mail can be accommodated given that the private addresses can be generated by the participating ISP upon request and sent to a bulk mailing service, which would then be able to send messages to each user in the list.

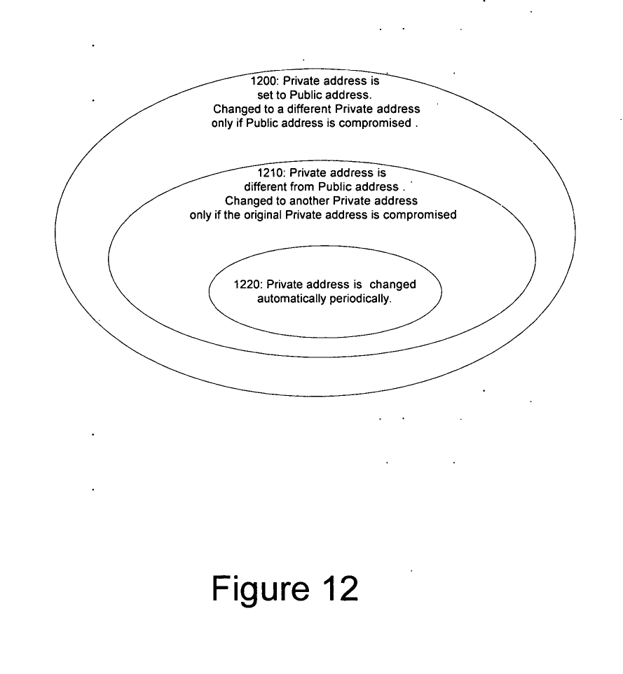

FIG. 12 illustrates a progression of exemplary security tightening levels in the event a private address is compromised, in accordance with an embodiment of the present invention. Shown are progressive steps, denoted by concentric circles, to be taken to correct a security breach on the previous level denoted by an outer ring. The levels are depicted as concentric rings where each inner ring represents a more stringent security level where tighter security imposes greater restrictions on the private addresses. Each subsequent inner ring represents the next level security should the previous level were compromised. By way of example, and not limitation, we start with the most outer ring 1200 where the private address associated with some source address is the same as the public address, In the event that private address is compromised the system proceeds to the next level 1210 where the private address is changed by possibly appending the user name with a character string. However it is changed only for the one source address. The most inner level 1220 depicts a situation where the private address is automatically changed at some random time. Note that if both individuals are behind an Email Firewall then the automatic change of private address is not noticeable since in this case private addresses are hidden from the users and public addresses are used to communicate.

It is contemplated that the described embodiments of the present invention can be used in a variety of communication systems where a subscriber wishes to have control of who can communicate with him/her, and may be applied, without limitation, where the addressing scheme is: 1) a hierarchical partitioning of the address space, 2) each lowest sub-partition has sufficiently large poof of admissible addresses to allow each location within the lowest sub-partition to have a possibly different virtual address for each delivery source, 3) the possibly different addresses assigned to the same location have identical parts, with the possible exception of the lowest sub-partition, that identify partition levels in the hierarchy 4) there is a feasible means of registering the source address with the administrator of the lowest address partition, 5) and there is a feasible means of notifying the sender at the source address which virtual address to use to reach the destination. The subscriber may have a different private (virtual) address for each source address and it is up to the lowest partition level to route messages to the correct subscriber.

By way of example, and not limitation, the foregoing embodiment may be applied to regular postal mail for eliminating unwanted postal mail (junk mail). The post office address fits the hierarchical address scheme, where the hierarchy levels are: Country, state, city, zip, street address. To apply our invention to postal mail we would assign possibly a different virtual street address for each source but keep the country, state, city and zip in tact. Postal mail would get through to the local post office regardless what the street address is. If at the local post office it is determined that the destination virtual address matches the source (return) address then the mail would be delivered otherwise it would be blocked. Notification to register could be done by regular mail and registration could be done by phone, regular mail or on the web. Again the private (virtual) address may the same as the public address and mail will get through as long as the sender is registered. However, if a public address is spoofed then a different private address would be assigned for the source address that has been spoofed.

By way of another example, and not limitation, the foregoing embodiments may be directly applied to Voice over Internet Protocol (VoIP) telephony if both the sender and the recipient are Using the internet directly. The invention also applies when the VoIp communication is from a public switched telephone network (PSTN) foflowed by the internet (VoIP) and back to PSTN. Here we are mapping from one hierarchical address space PSTN to another hierarchical address space (VoIP) and then back to PSTN. In this case the sources as well as the destination ISP would need to keep track of the sender's private address to enable the mappings. The registration would take place at the destination ISP which would then forward the generated private address to the source ISP.

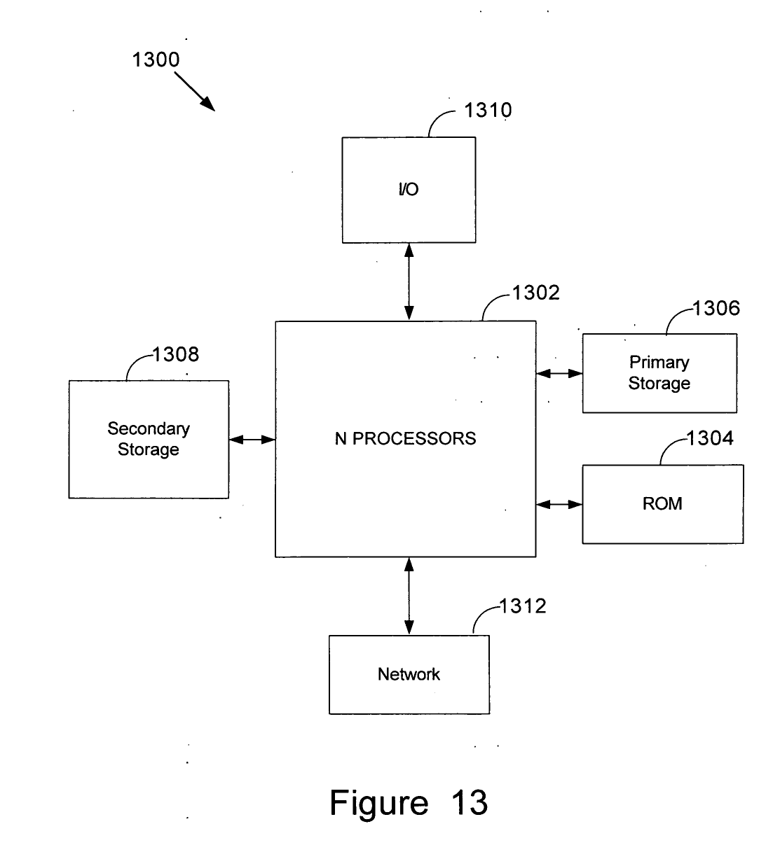

FIG. 13 illustrates a typical computer system that, when appropriately configured or designed, can serve as a computer system in which the invention may be embodied. The computer system 1300 includes any number of processors 1302 (also referred to as central processing units, or CPUs) that are coupled to storage devices including primary storage 1306 (typically a random access memory, or RAM), primary storage 1304 (typically a read only memory, or ROM). CPU 1302 may be of various types including microcontrollers and microprocessors such as programmable devices (e.g., CPLDs and FPGAs) and unprogrammable devices such as gate array ASICs or general purpose microprocessors. As is well known in the art, primary storage 1304 acts to transfer data and instructions uni-directionally to the CPU and primary storage 1306 is used typically to transfer data and instructions in a bi-directional manner. Both of these primary storage devices may include any suitable computer-readable media such as those described above. A mass storage device 1308 may also be coupled bi-directionally to CPU 1302 and provides additional data storage capacity and may include any of the computer-readable media described above. Mass storage device 1308 may be used to store programs, data and the like and is typically a secondary storage medium such as a hard disk. It will be appreciated that the information retained within the mass storage device 1308, may, in appropriate cases, be incorporated in standard fashion as part of primary storage 1306 as virtual memory. A specific mass storage device such as a CD-ROM 1314 may also pass data uni-directionally to the CPU.

CPU 1302 may also be coupled to an interface 1310 that connects to one or more input/output devices Such as such as video monitors, track balls, mice, keyboards, microphones, touch-sensitive displays, transducer card readers, magnetic or paper tape readers, tablets, styluses, voice or handwriting recognizes or other well-known input devices Such as, of course, other computers. Finally, CPU 1302 optionally may be coupled to an external device Such as a database or a computer or telecommunications or Internet network using an external connection as shown generally at 1312. With such a connection, it is contemplated that the CPU might receive information from the network, or might output information to the network in the course of performing the method steps described in the teachings of the present invention.

Those skilled in the art will readily recognize, in accordance with the teachings of the present invention, that any of tie foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

Having fully described at least one embodiment of the present inventions other equivalent or alternative methods of implementing all Email Firewall according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A method for an email firewall in a client-server environment where a sender using an email client emails an email from an associated source email address to a destination email address associated with a recipient, the method comprising the steps of:
providing the sender with a privatized recipient email address that the sender can use for emailing email to the recipient via an email networking infrastructure, said privatized recipient email address being configured to be operable, from designated source address(es), for enabling the email networking infrastructure to direct an email addressed to said privatized recipient email address to a firewalled destination email server; and
upon receiving an email addressed to said privatized recipient email address, said firewalled destination email server validating that the received email was sent from a registered sender address at least by searching a validation database for the sender's email address and the associated privatized recipient's email address, and if the sender's email address and the associated privatized email address are found, replacing said privatized recipient email address with a public email address associated with the recipient and forwarding said received email for delivery to the recipient's email server and subsequently to the recipient's email client.

2. The email firewall method of claim 1, further comprising the Step of if after searching said validation database for the sender's email address the sender's email address is not found, sending an email to the sender indicating the email was blocked and optionally providing information on how to register.

3. The email firewall method of claim 1, in which, the Step of registering comprises the Step of after the sender registers, emailing said privatized recipient email address to the sender's email address.

4. The email firewall method of claim 1, in which, generating said privatized recipient email address comprises the Step of embedding a unique identifier into the destination email address.

5. The email firewall method of claim 4, in which, replacing said privatized recipient email address with a public email address comprises the Step of removing said unique embedded identifier alter it is verified by said email firewall.

6. The email firewall method of claim 1, in which, the email networking infrastructure is a conventional fundamental store-and-forward model within the framework of conventional email protocols.

7. The email firewall method of claim 1, in which, email sender is not a subscriber to a service based on said email firewall method, and the email recipient is such a subscriber.

8. A method for an email firewall in a client-server environment where a sender, having a public source email address protected by an email firewall and using an email client, emails an to a destination email address, not protected by an email firewall, associated with a recipient, the method comprising the steps of:
a firewalled source email server checks a validation database to determine if the destination address is in the validation database;
if the destination address is not in the validation database, the email-firewall generating a privatized return address associated with the source public address and the recipient's email address and enters them into said validation database;
if the destination address is in the validation database, the email-firewall retrieves a return private address associated with the destination address from the validation database;
replacing the public return address associated with the sender with said privatized return address, thereby enabling the email to be emailed via an email networking infrastructure to the destination address;
encrypting the public source address and inserting it into a hidden header field, said hidden header field being configured Such that said hidden header field will be ignored by all email transfer agents except for a destination email server is an email-firewall server of the present method; and
reconfiguring said return privatized email address to be operable for enabling the email networking infrastructure to direct a reply email sent from the recipient back to said firewalled source email client.

9. The email firewall method of claim 8, in which, generating said privatized sender email address comprises the Step of embedding a unique identifier into the local part of the public source email address associated with the sender.

10. The email firewall method of claim 8, in which, the email-firewall encrypts the public source address and inserts the encrypted address in a hidden email header field; the encrypted header file will be ignored by all email transfer agents and the destination email server unless the destination server is a firewall email server.

11. The email firewall method of claim 8, in which, the email networking infrastructure is a conventional fundamental store-and-forward model within the framework of conventional email protocols.

12. The email firewall method of claim 8, in which, email recipient is not a subscriber to a service based on said email firewall method, and the email sender is such a subscriber.

13. A method for an email firewall in a client-server environment where a sender using an email client emails an email having a public source email address protected by an email firewall to a public destination email address protected by an email firewall associated with a recipients the method comprising the steps of
a firewalled source email server checking, a first (source) validation database for the destination address;
if the destination address is not in the validation database, the email-firewall generating a privatized return address associated comprising the source public address and the recipient's email address;
storing said privatized return address into said validation database:
replacing the public return address associated with the sender with said privatized return address, thereby enabling the email to be emailed via an email networking infrastructure to the destination address;
encrypting the public source address and inserting it into a hidden header field, said hidden header field being configured such that said hidden header field will be ignored by all email transfer agents except for a destination email server is an email-firewall server of the present method; and
reconfiguring said return privatized email address to be operable for enabling the email networking infrastructure to direct a reply email sent from the recipient back to said firewalled source email client.

14. The email firewall method of claim 13, further comprising the Steps of providing the recipient email firewall with a privatized return email address that the recipient Firewall can use for emailing email back to the sender firewall via the email networking infrastructure, said privatized sender email address being configured to be operable for enabling the email networking infrastructure to direct an email addressed to said privatized sender email firewall:
upon receiving an email said firewalled recipient's email server searching if the received email was sent from a sender email address that is registered in a validation database associated therewith;
if not found, checking for said encrypted hidden header field;
if the encrypted header field is found, generating a private address associated with the decrypted public address of the sender;
storing in a validation database associated with said firewalled recipient's email server, said generated private address and said decrypted public source address;
storing in a validation database associated with said firewalled recipient's email server, said privatized source address and the destination public address;
said firewalled recipient's email server transmitting the sender using the sender's private address and the associated private return address with the associated encrypted public address in a hidden header field, the sent email being operable as a verified email that is from a legitimate source address, as confirmed by the encrypted hidden header field: and
transmitting said verified email to the recipient email server, which in turn forwards it to the recipient client.

15. The email firewall method of claim 14, further comprising the Steps of said sender firewall Upon receiving the automated return message from the recipient firewall checks that it is a message from a firewall by checking the encrypted hidden header field and further checks its validation database if the private return address is in the database and if not stores the return private address together with the associated sender's public address and the decrypted recipient's public address The sender and the recipient can from now on communicate using public address because the firewall logic in each firewall can look up the respective private address in their respective validation databases.

16. The email firewall method of claim 15, where the firewalled source email server checks the first (source) validation database if the destination address is in the validation database. If the destination address is in the validation database, the firewall logic retrieves the corresponding, destination private address, the return private address and the return pubic address and inserts them into the To: header field, the From: header field and, the hidden encrypted header field respectively and forwards the message to the destination; and, upon the arrival of the email at the destination firewall the destination private address is validated at the second (destination) validation database, the private addresses are replaced by their corresponding public addresses in the To: and From: header fields and the email is forwarded to the recipient email server which in turn forwards the email to the recipient email client.

17. The email firewall method of claim 15, in which said hidden header field is configured such that it Would be ignored by email transfer agents comprised in the email networking infrastructure but can be parsed by the destination email firewall software of said email firewall method.

18. The email firewall method of claim 15, when the recipient email firewall detects through the encrypted header field that the email is from an email firewall can optionally switch to communication via a secure socket layer.

19. The email method of claim 18, is such that it is does not require a central database to keep track of all the installed email firewalls: A firewall can detect a message from another firewall by checking for an encrypted header field.

20. The email method of claim 13 retrieves the destination private address and the return private address from the validation database and places them in the respective To: and From: header fields for outgoing mail and for incoming mail the destination firewall logic removes the private addresses and replaces them with their corresponding public address before forwarding the email to the destination email server; this renders communication between firewalls to be completely transparent.

21. The email method of claim 18 can optionally switch to a secure socket layer communication once the destination email firewall determines that a message is from an email firewall.
